(19) United States
(12) Patent Application Publication
(10) Pub. No.: US 2020/0300394 A1
(43) Pub. Date: Sep. 24, 2020

(54) TUBING RETAINER

(71) Applicant: NORDSON CORPORATION, WESTLAKE, OH (US)

(72) Inventors: Peter D. Lewis, Loveland, CO (US); Francis J. Lombardi, Loveland, CO (US)

(21) Appl. No.: 16/651,394

(22) PCT Filed: Oct. 2, 2018
(86) PCT No.: PCT/US2018/053901

§ 371 Date: Mar. 27, 2020

Related U.S. Application Data
(60) Provisional application No. 62/567,693, filed on Oct. 3, 2017.

(51) Int. Cl. F16L 33/035

(52) U.S. Cl. CPC F16L 33/035; B65D 63/1063

(57) ABSTRACT

A tube connection system is disclosed that includes a barb connection, a tube received on the barb connection, and a retainer for maintaining the tube over the barb connector. The retainer includes a first elongate strap, a second elongate strap that is parallel to the first elongate strap, and a bridge between said first and second elongate straps, said bridge transversely spacing said first and second elongate straps by a predetermined first distance. The retainer also includes a first lock for locking said first elongate strap and a second lock for locking said second elongate strap.

### CROSS REFERENCE TO RELATED APPLICATIONS

This application claims the benefit of U.S. Provisional Patent App. No. 62/567,693, filed Oct. 3, 2017, the disclosure of which is hereby incorporated by reference herein.

### TECHNICAL FIELD

The present invention relates to a retainer for maintaining a tube over a barb connector, a system comprising such a retainer and a method of maintaining a tube against a barb connector. More particularly, the invention finds application in the biopharma or bioprocess industry for maintaining tubes to barb connectors.

### BACKGROUND

Bioprocessing and pharmaceutical manufacturing involve fluid transfer via biopharma tubing systems, which can include components such as barbed fittings or connectors, filters, and line sets. Line sets or tube sets refer to components including tubing, barbed fittings or connectors, and tubing retainers that are designed and assembled for a specific fluid transfer procedure. The volume inside the tubing and barb connector is important to the specific transfer procedure, because volume changes due to factors such as tubing expansion (ballooning) during fluid transfer can have negative effects.

The function of tube retainers is to decrease the chances of inadvertently disconnecting a piece of tubing from a barbed fitting to which it is connected. For example, it may take 135 N of force to axially pull a tube with an inner diameter of 0.5 inches (12.7 mm) from a conventional barb connector, whereas the addition of conventional types of tube retainers can increase the force required to remove the tubing by about 25-60%, depending on the retainer used and the materials involved.

One common type of tube retainer used in biopharma tubing systems is a cable tie. Cable ties provide many benefits, as they are inexpensive and easy to use. Further, the force and tension that assembled cable ties apply to a particular piece of tubing and a barbed fitting may be easily controlled, such as by a cable tie gun that has adjustable tensioning features. Cable tie guns can also cut any excess length from the cable ties so that the end of a cable tie is flush with the cable tie lock. However, one problem with cable ties is that they are unable to completely engage the entire circumference of a piece of tubing. When the cable tie is locked, the normally square shape of the cable tie lock prevents the cable tie from crimping the entire circumference of the tubing, in particular the area directly under the lock. This can create an area with less radial tension applied, which can ultimately result in an unsealed region between the tubing and the barb connector. Cable ties can also cause ballooning of the tubing, which involves expansion of the tubing radially away from the barb connector around the region of the tubing where the cable tie secures the tubing to the barb connector.

Other known types of tube retainers include sleeve type elements, also referred to as barb locks, which are provided around the tube and can be pushed over a region of tubing that overlies a tapered portion of the barb connector. Barb locks may, to a certain degree, prevent the problem of ballooning, as they maintain the tube in close, continuous contact with the tapered portion of the barb connector. However, barb locks are relatively expensive and cannot be retrofitted to certain tube designs.

Another known alternative to cable ties are metal clamps that commonly have a greater width than cable ties and can include a texture or structured surface at a radially inner portion, which increases durability. However, metal clamps are expensive and do not address the problem of ballooning, as they are secured to the tubing and barb connector in a similar manner to cable ties. Also, if metal clamps are tied around the tapered portion of the barb connector, they may slip off during operation of the tubing system, which can result in a reduction in tightening force and ultimately may lead to an unsealed connection.

Therefore, there is a need for a retainer for maintaining a tube over a barb connector which prevents ballooning in the area of the barb connector, and provides an even force distribution around the tube when the tube is received over the barb connector.

### SUMMARY

An embodiment of the invention is a retainer for maintaining a tube over a barb connector. The retainer includes a first elongate strap and a second elongate strap that is parallel to the first elongate strap. The retainer also includes a bridge between said first and second elongate straps, said bridge transversely spacing said first and second elongate straps by a predetermined first distance, a first lock for locking said first elongate strap, and a second lock for locking said second elongate strap.

Another embodiment of the invention is a retainer for maintaining a tube over a barb connector. The retainer includes a curved base for contacting an outer surface of the tube, a first elongate strap, and a second elongate strap that is parallel to the first elongate strap, the first and second elongate straps extending from the curved base. The retainer also includes a first lock for locking said first elongate strap and a second lock for locking said second elongate strap, the first and second locks connected to the curved base.

A further embodiment of the invention is a tube connection system that includes a barb connector defining a conduit therein, said barb connector having a terminal end, a cylindrical portion, and a tapered portion between said terminal end and said cylindrical portion, the tapered potion having a maximum outer diameter that is greater than an outer diameter of the cylindrical portion. The tube connection system includes a tube received on said barb connector and extending at least over both said cylindrical portion and said tapered portion, and a retainer for maintaining said tube over said barb connector. The retainer includes a first elongate strap, a second elongate strap that is parallel to the first elongate strap, and a bridge between said first and second elongate straps, said bridge transversely spacing said first and second elongate straps by a predetermined first distance. The retainer also includes a first lock for locking said first elongate strap, and a second lock for locking said second elongate strap, where said first elongate strap secures said tube against said cylindrical portion, and said second elongate strap secures said tube against said tapered portion.

An embodiment of the invention is a method of maintaining a tube against a barb connector. The method includes disposing the tube over the barb connector and providing a first elongate strap and a second elongate strap of a retainer around the tube, where said first and second elongate straps are transversely spaced by a bridge. The method also includes guiding said first and second elongate straps through respective first and second locks and tightening said first and second elongate straps against the tube such that the first elongate strap is around a first portion of the tube and the second elongate strap is around a second portion of the tube.

### BRIEF DESCRIPTION OF THE DRAWINGS

The accompanying drawings, which are incorporated and constitute a part of this specification, illustrate embodiments of the invention and, together with a general description of the invention given above and the detailed description given below, serve to explain the invention. It should be understood, however, that the application is not limited to the precise arrangements and instrumentalities shown.

FIG. 1 is a perspective view of a tube connection system according to an embodiment of the present invention;

FIG. 2 is a further perspective view of the tube connection system shown in FIG. 1;

FIG. 3 is a further perspective view of the tube connection system shown in FIG. 1;

FIG. 4 is a cross-sectional view of the tube connection system shown in FIG. 1;

FIG. 5 is a perspective view of a tube used in the tube connection system shown in FIG. 1;

FIG. 6 is a perspective view of a barb connector used in the tube connection system shown in FIG. 1;

FIG. 7 is a perspective view of a retainer used in the tube connection system shown in FIG. 1;

FIG. 8 is a side view of the retainer shown in FIG. 7;

FIG. 9 is a top view of the retainer shown in FIG. 7; and

FIG. 10 is a perspective rear view of the retainer shown in FIG. 7.

### DETAILED DESCRIPTION

Certain terminology is used to describe the tube connection system 1 in the following description for convenience only and is not limiting. The words “right,” “left,” “lower,” and “upper” designate directions in the drawings to which reference is made. The words “inner” and “outer” refer to directions toward and away from, respectively, the geometric center of the description to describe the tube connection system 1 and related parts thereof, which may be along the radial direction R. The words “proximal” and “distal” refer to directions along the axial direction A. The terminology includes the above-listed words, derivatives thereof, and words of similar import.

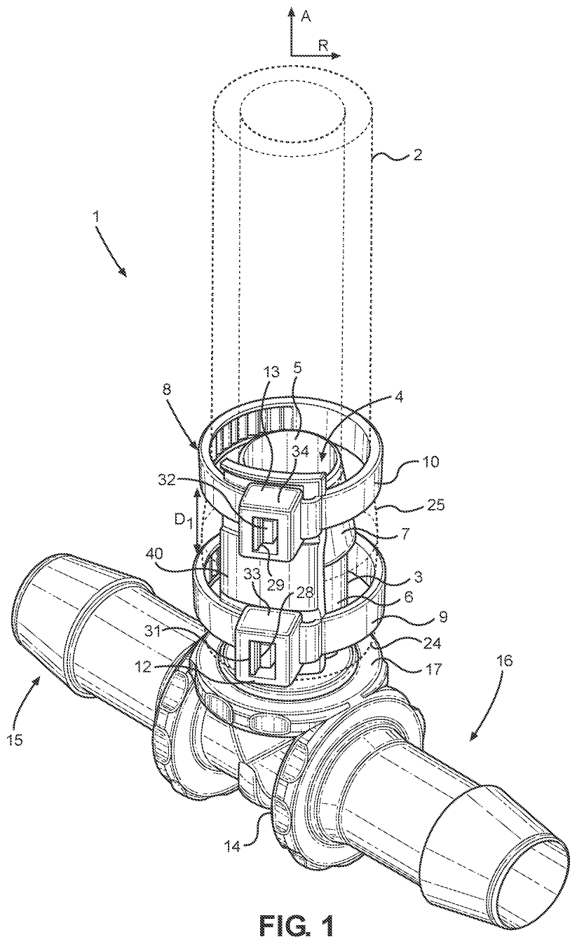

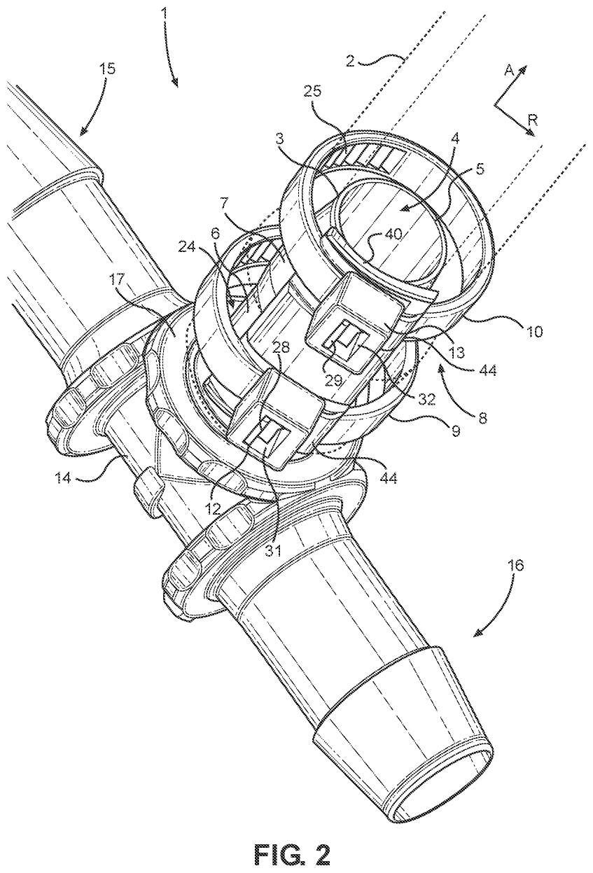

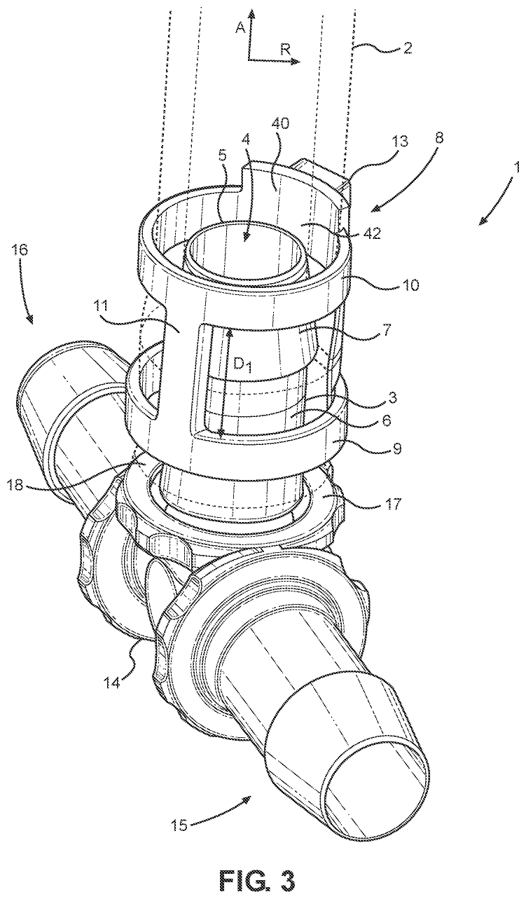

Referring to FIGS. 1-10, in one exemplary embodiment of the invention, a tube connection system 1 is provided for maintaining a tube 2 on a barb connector 3 that defines a conduit 4 therein. The barb connector 3 includes a terminal end 5, a cylindrical portion 6, and a tapered portion 7 disposed between the terminal end 5 and the cylindrical portion 6 along the axial direction A. The tapered portion 7 has a maximum outer diameter DM that is greater than an outer diameter DC of the cylindrical portion 6. The tube 2 is received on the barb connector 3 and extends at least over both the cylindrical portion 6 and the tapered portion 7. A retainer 8 for maintaining the tube 2 over the barb connector 3 is provided. The retainer 8 comprises a first elongate strap 9, a second elongate strap 10 that can be parallel to the first elongate strap 9, and a bridge 11 that extends from the first elongate strap 9 to the second elongate strap 10. The bridge 11 may extend in a direction substantially perpendicular to the first and/or second straps 9, 10, though other configurations are contemplated. The bridge 11 transversely spaces the first and second elongate straps 9, 10 apart by a predetermined first distance D1. Moreover, the retainer 8 includes a first lock 12 for locking the first elongate strap 9 around the barb connector 3 and a second lock 13 for locking the second elongate strap 10 around the barb connector 3. According to this exemplary embodiment, the first elongate strap 9 secures the tube 2 to the cylindrical portion 6 of the barb connector 3, while the second elongate strap 10 secures the tube 2 against the tapered portion 7 of the barb connector 3. Each element of the tube connection system 1 can be manufactured from a substantially rigid material, such as stainless steel or a rigid plastic material. Additionally, each element of the tube connection system 1 can be comprised of the same material, or each element may comprise a different material.

With reference to FIGS. 1-4 and 6, the barb connector 3 is part of a connector assembly 14, which also includes two further barb connectors 15, 16 that extend opposite to each other and substantially perpendicular to the barb connector 3 on which the tube 2 is received. The conduit 4 runs through all three barb connectors 3, 15, 16 such that all three barb connectors 3, 15, 16 are in fluid communication with each other. However, this is only exemplary and other types of connector assembly 14 can be used within the scope of this invention when they include a barb connector 3. For example, in other embodiments the barb connector 3 can include more than three barb connectors (not shown), and each of the barb connectors can be oriented differently to each other as desired. Also, in the embodiment shown in FIGS. 1-4 and 6 only one tube 2 is shown positioned on one of the barb connectors 3, 15, 16. This is done for clarity reasons only, and in practice there can be a tube received on each of the three barb connectors 3, 15, 16 to allow fluid communication between the different tubes and to build a complete tubing system.

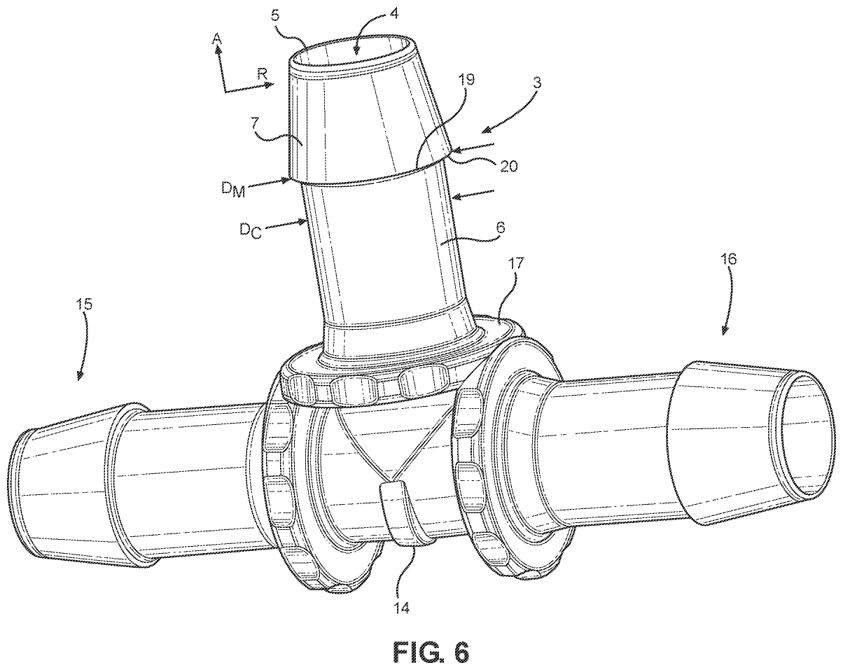

As shown in FIG. 6, the barb connector 3 includes a terminal end 5, and a tapered portion 7 that extends from the terminal end 5 to a maximum diameter end 19 of the tapered portion 7 that is spaced from the terminal end 5 along the axial direction A. The tapered portion 7 tapers inward along the radial direction R as the tapered portion 7 extends toward the terminal end 5 of the barb connector 3, such that the tapered portion 7 defines the maximum diameter DM at the maximum diameter end 19. As such, the tapered portion 7 can define the shape of a truncated cone. The barb connector 3 further defines a step 20 that extends from the tapered portion 7 towards an abutment 17 along the axial direction A and defines a recess. The step 20 may extend substantially in the radial direction R, but may also be slightly tapered. The cylindrical portion 6 extends along the axial direction A from the step 20 to the abutment 17. In addition to the embodiment described above, other configurations of the barb connector 3 are also contemplated. For example, the cylindrical portion 6 may define a polygonal, elliptical, or other cross section as desired. The tapered portion 7 may linearly taper from the maximum diameter end 19 to the terminal end 5, or may taper along a concave or convex curve. Moreover, it is not required that the tapered portion 7 terminates at the terminal end 5 of the barb connector 3. Rather, the tapered portion may terminate at a location between the terminal end 5 and the maximum diameter end 19, and a second cylindrical portion (not shown) may be provided that extends from the tapered portion 7 to the terminal end 5 of the barb connector 3. A diameter of the tapered portion 7 at the terminal end 5 may be greater, identical, or less than the outer diameter DC of the cylindrical portion.

Continuing with FIG. 6, the barb connector 3 defines an abutment 17 that extends from the cylindrical portion 6 substantially along the radial direction R. The abutment 17 has a diameter that is greater than the outer diameter DC of the cylindrical portion 6 and the maximum diameter DM of the tapered portion 7. When the tube connection system 1 is assembled, the tube 2 is pushed over the barb connector 3 such that a first axial end 18 of the tube 2 is disposed at a location along the cylindrical portion 6 that is spaced from the abutment 17. As shown in FIGS. 1-4, a small gap is formed between the first axial end 18 of the tube and the abutment 17. However, in some embodiments the tube 2 can be disposed over the barb connector 3 such that the first axial end 18 of the tube 2 contacts the abutment 17.

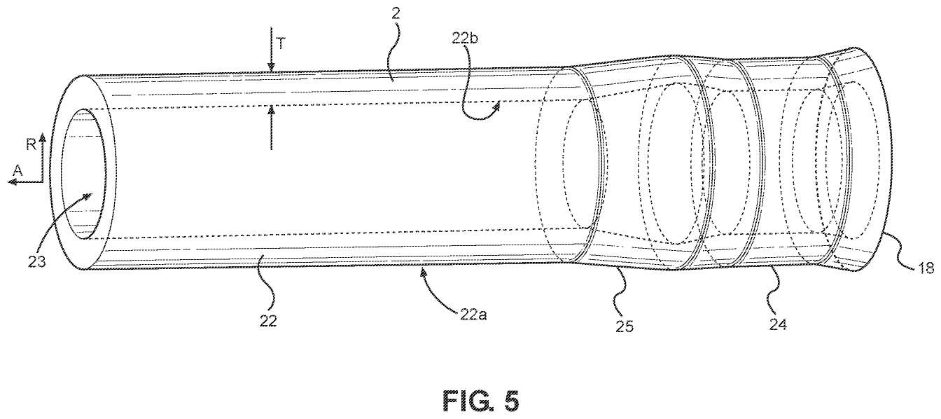

Referring to FIG. 5, the tube 2 is substantially cylindrical in its relaxed state and comprises a wall 22 that defines a thickness T measured along the radial direction R. The wall 22 can have a substantially constant thickness T along the axial direction A, though a variable thickness is also contemplated. The wall 22 has an outer surface 22a and an inner surface 22b opposite the outer surface 22a along the radial direction R. The wall 22 can extend from a first axial end 18 to a second axial end (not shown) that is spaced from the first axial end 18 along the axial direction A. The tube 2 can define a first tube portion 24 and a second tube portion 25 that is spaced from the first tube portion 24 along the axial direction A. The first tube portion 24 can be positioned between the second tube portion 25 and the first axial end 18 along the axial direction A. The tube 2 may have a preformed shape at the first and second tube portions 24, 25 such that the outer surface 22a substantially conforms to the outer surface of the barb connector 3. Alternatively, the outer and inner surfaces 22a, 22b of the tube 2 can be substantially straight. The tube 2 can be formed from an elastic material, such as any elastic plastic material. The tube 2 may be translucent, which allows service personnel to view material flowing through a hollow lumen 23 formed within the tube 2. As the tube 2 can be made out of a flexible material, the tube 2 can expand when pressure is applied.

Conventional retainers only maintain a seal between the tube 2 and the barb connector 3 at the cylindrical portion 6 of the barb connector 3, so that the step 20 prevents the retainer from slipping off the barb connector 3, and likewise prevents the tube 2 from slipping off the barb connector 3. A common problem associated with flexible tubes connected to barb connectors 3 in this way is ballooning of the tube. After the tube 2 is disposed over the barb connector 3 and upon application of pressure from the retainer, the tube 2 can expand radially at a location spaced between the retainer and the terminal end 5 of the barb connector 3, which can result in an incomplete seal between the tube 2 and the tapered portion 7. Additionally, a conventional retainer that is attached to the tube 2 and crimps the tube 2 against the cylindrical portion 6 of the barb connector 3 can loosen, which also results in the tube 2 axially sliding off the barb connector 3. Further, conventional retainers include square locks for receiving the retainer straps, which when contacting the tube 2 cause the retainer to not apply pressure to the tube 2 around its complete circumference, thus further resulting in an incomplete seal between the tube 2 and the barb connector 3.

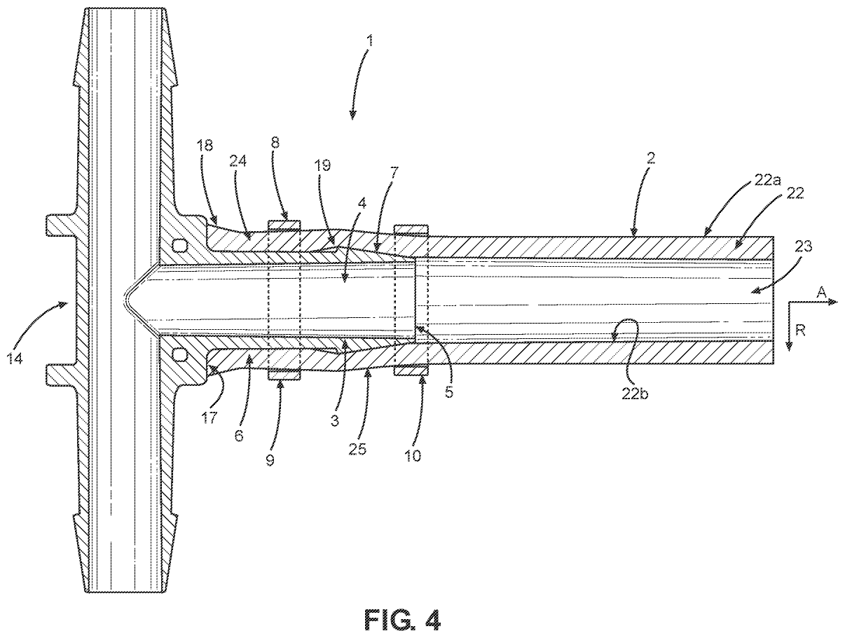

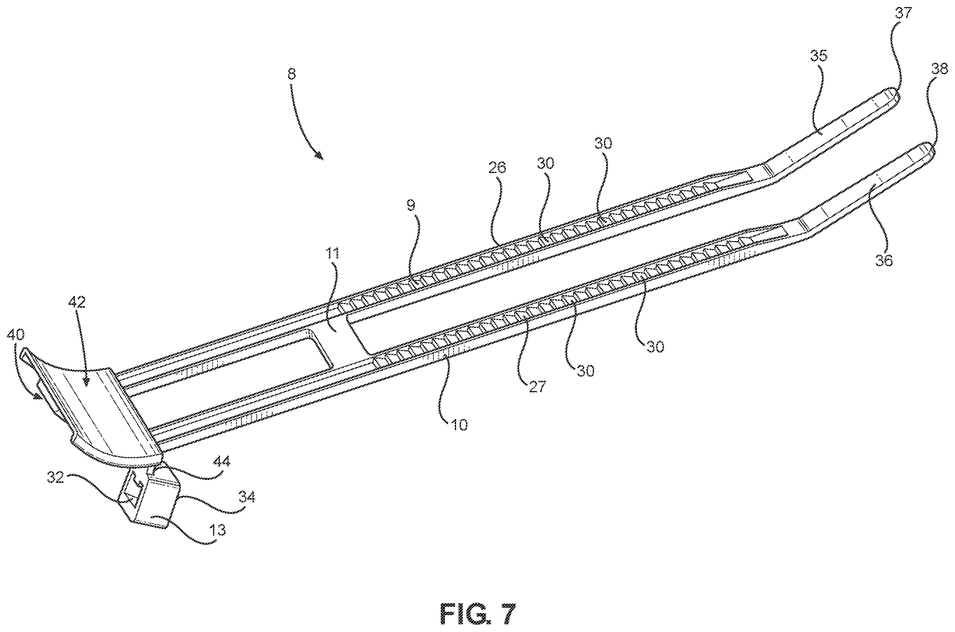

To overcome these drawbacks of the prior art, the invention in one exemplary embodiment includes the retainer 8 for maintaining the tube 2 in a sealed connection with the barb connector 3. Referring to FIGS. 7-10, the retainer 8 includes a first elongate strap 9 and a second elongate strap 10. The first and second elongate straps 9, 10 can extend parallel to each other. A bridge 11 can extend from the first elongate strap 9 to the second elongate strap 10 in a direction that is perpendicular to the first and second elongate straps 9, 10, and functions to transversely space the first and second elongate straps 9, 10 apart by a predetermined first distance D1. The retainer 8 can be formed having a single one-piece body and molded from plastic material. However, other materials such as metal can be suitable. The retainer 8 also includes a first lock 12 for locking the first elongate strap 9 when the first elongate strap 9 is disposed around the tube 2, and a second lock 13 for locking the second elongate strap 10 when the second elongate strap 10 is disposed around the tube 2. In particular, referring to FIG. 4, the first elongate strap 9 can be positioned and tied around the first tube portion 24, while the second elongate strap 10 can be positioned and tied around the second tube portion 25. The first and second tube portions 24, 25 can be spaced apart along the axial direction A by the first predetermined distance D1. The first tube portion 24 can be placed over the cylindrical portion 6 of the barb connector 3 and the second tube portion 25 can be placed over the tapered portion 7 of the barb connector 3. By securing the retainer 8 to both the first and second tube portions 24, 25, ballooning of the tube 2 that occurs typically in the region of the second tube portion 25 when only a single retainer strap is used can be prevented.

For securing and subsequently maintaining the tube 2 in a sealed engagement with the barb connector 3, the tube 2 first is pushed over the barb connector 3 such that both the tapered portion 7 and the cylindrical portion 6 are disposed in the hollow lumen 23 of the tube 2. Then the retainer 8 is placed against the tube 2, in particular contacting the outer surface 22b in the regions of the first and second tube portions 24, 25. The elongate straps 9, 10 are placed around the outer surface 22b and locked using the first and second locks 12, 13. The straps are tightened to bias the tube 2 against both the cylindrical portion 6 and the tapered portion 7 of the barb connector 3. The bridge 11 maintains the distance D1 between the first and second elongate straps 9, 10 in this tied condition such that the second elongate strap 10 will not move away from or toward the first elongate strap 9 during use of the tube connection system 1.

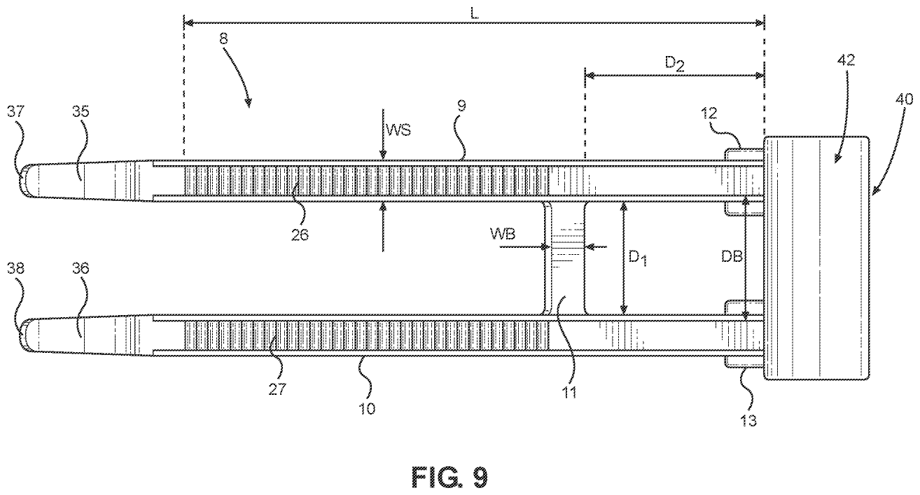

The bridge 11 has a length that allows the first and second elongate straps 9, 10 to be spaced apart by the first predetermined distance D1. Preferably, the bridge 11 connects the first and second elongate straps 9, 10. The bridge 11 may be joined to the first and second straps 9, 10, or integrally formed therewith. The bridge 11 is shown in the drawings FIGS. 1-3 and 8-10 to be substantially strap-like and extending perpendicular to the first and second elongate straps 9, 10. As it becomes apparent from FIG. 9 in particular, the width WB of the bridge 11 can be substantially the same as the width WS of the first elongate strap 9. It shall be noted that the first and second elongate straps 9, 10 in this embodiment are substantially identical. As such, the width of the second elongate strap 10 is equal to the width WS. However, the bridge 11 may also be of any other shape as long as it spaces the first and second elongate straps 9, 10 by the first predetermined distance D1. The bridge 11 may also have a different width WB or may taper towards the first and/or second elongate straps 9, 10. The width WB of the bridge 11 should be in such a range that winding the first and second elongate straps 9, 10 around the tube 2 is still feasible. The bridge 11 may be solid to withstand tensioning forces acting on the first and/or second elongate strap 9, 10 during use of the tube connection system 1. Though only one bridge 11 is shown, the retainer 8 can include more than one bridge, such as a second and a third bridge that are offset and parallel to the bridge 11. More than one bridge can be utilized in retainers 8 that define relatively long first and second elongate straps 9, 10, or in conjunction with tubes 2 that define a relatively large diameter.

The first and second elongate straps 9, 10 can include respective first end second jagged engagement surfaces 26, 27. The face opposite the first and second jagged engagement surfaces 26, 27 in the depicted embodiment can be substantially flat and smooth. This smooth face is usually radially outside and faces away from the tube 2 when the retainer 8 is mounted to the tube 2. The first and second locks 12, 13 can include respective first and second locking jacks 28, 29 for engagement with said first and second jagged engagement surfaces 26, 27, respectively. Each of the first and second jagged engagement surfaces 26, 27 comprises a plurality of teeth or jacks 30 (only two of which are provided with reference signs in FIG. 7) that extend outwardly from the first and second elongate straps 9, 10 and form first positive engagement elements. The plurality of jacks 30 can be spaced apart along the length of the first and second elongate straps 9, 10 in equal, incremental distances. The first and second locking jacks 28, 29 of the first and second locks 12, 13 form second positive engagement elements which engage with the jacks 30 of the first and second jagged engagement surfaces 26, 27, respectively, to lock the position of the first and second elongate straps 9, 10 with respect to the first and second locking jacks 28, 29.

To lock each of the first and second elongate straps 9, 10 to the respective first and second locks 12, 13, the first elongate strap 9 is guided through an opening 31 defined by the first housing 33 of the first lock 12, into which the first locking jack 28 protrudes, and the second elongate strap 10 is guided through an opening 32 defined by the second housing 34 of the second lock 13, into which the second locking jack 29 protrudes. As the first elongate strap 9 is guided through the opening 31, the first locking jack 28 engages with subsequent jacks 30 of the first jagged engagement surface 26. Similarly, as the second elongate strap 10 is guided through the opening 32, the second locking jack 29 engages with subsequent jacks 30 of the second jagged engagement surface 27. Engagement between the first and second locking jacks 28, 29 and the jacks 30 of the first and second jagged engagement surfaces 26, 27, respectively, allows the first and second elongate straps 9, 10 to be guided further through the openings 31, 32 to further tighten the retainer 8, but prevents the first and second elongate straps 9, 10 from being guided back out of the openings 31, 32. As a result, in one embodiment the first and second locking jacks 28, 29 can only be disengaged from the first and second elongate straps 9, 10 by destroying the first and second locks 12, 13. However, in other embodiments it is contemplated that the first and second locking jacks 28, 29 can be disengaged from the first and second elongate straps 9, 10 without destroying any portion of the retainer 8. In the tightened condition, the first and second jagged engagement surfaces 26, 27 can face inward toward the tube 2 such that the jacks 30 contact the outer surface 22a. This configuration can prevent material from getting trapped by the jacks 30.

To guide the first and second elongate straps 9, 10 through the first and second openings 31, 32, respectively, the first elongate strap 9 can include a first gripping tongue 35 and the second strap 10 can include a second gripping tongue 36. The first gripping tongue 35 can extend from the first elongate strap 9 away from the first jagged engagement surface 26 and form a terminal end 37, while the second gripping tongue 36 can extend from the second elongate strap 10 away from the second jagged engagement surface 27 and form a terminal end 38. The first and second gripping tongues 35, 36 can extend from the first and second elongate straps 9, 10 in a direction that is slightly angled, such that the first and second gripping tongues 35, 36 are slightly angled with respect to the first and second jagged engagement surfaces 26, 27. This angular offset may help a user grab the elongate straps 9, 10 and guide them through the respective openings 31, 32 of the first and second housings 33, 34. The gripping tongues 35, 36 can also taper toward the terminal end 37, 38 and define a smaller width and/or smaller thickness to further improve guidance of the gripping tongues 35, 36 through the openings 31, 32.

The retainer 8 can also include a curved base 40 for contacting an outer surface 22a of the tube 2. The curved base can define a radially outer surface 41, and a radially inner surface 42 opposite the radially outer surface 41. The first and second elongate straps 9, 10 extend from the curved base 40. The first and second locks 12, 13 are connected the curved base 40. Preferably the curved base 40 transversely spaces the first and second elongate straps 9, 10 by a predetermined base distance DB from each other, as it is shown in FIG. 9. The base distance DB may equal the first distance D1, though the base distance DB and the first distance D1 can differ as desired. It shall be noted that when the retainer 8 includes the curved base 40, the bridge 11 is not absolutely necessary, as the first and second elongate straps 9, 10 are spaced apart by the curved base 40.

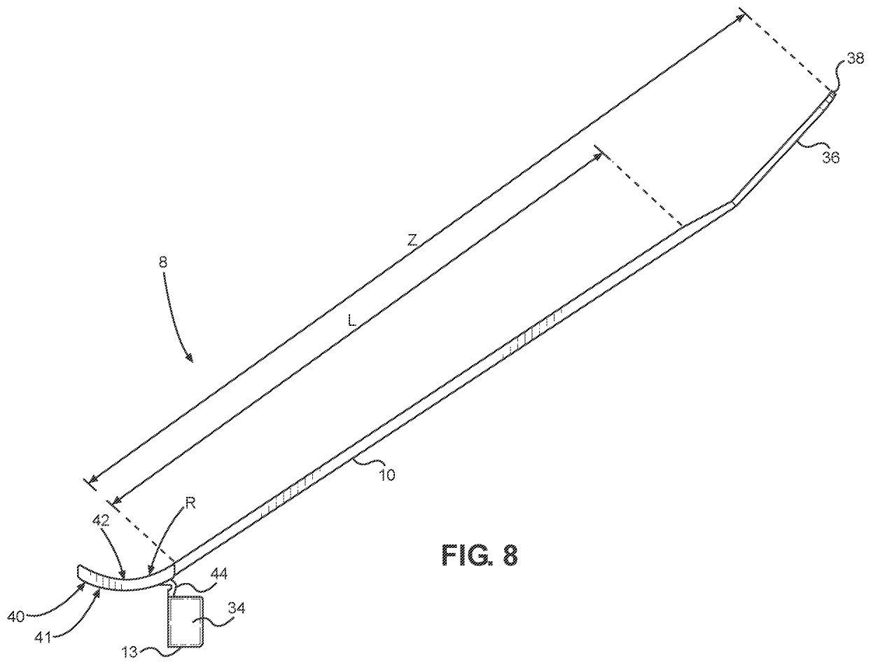

The first and second elongate straps 9, 10 can extend tangentially from the curved base 40. The curved base 40 preferably can have a curvature that is complementary to a curvature of the outer surface 22a of the tube 2 in the relaxed state. Alternatively, the curved base 40 can have a curvature that is slightly smaller than the curvature of the outer surface 22a. The curved base 40 can include an inner radius of curvature R (see FIG. 8) that equals or is less than the outer radius of curvature of the tube 2. The inner radius of curvature R may be 2 mm (0.078 inches) or larger, 5 mm (0.19 inches) or larger, 1 cm (0.39 inches) or larger, or even larger than 1 cm. The radius of curvature R can be determined based on the dimensions of commercially available tubes 2.

When the tube 2 is arranged over the barb connector 3, the curved base 40 is first brought into contact with the outer surface 22a of the tube 2. Then, the first and second elongate straps 9, 10 are laid around the tube 2 and passed through the openings 31, 32 of the first and second housings 33, 34, respectively, such that the retainer 8 is entirely wrapped around the tube. To tighten the first and second elongate straps 9, 10, the first and second elongate straps 9, 10 are pulled, such as by the first and second gripping tongues 35, 36, until the retainer 8 imparts a desired tension on the tube 2. The first and second elongate straps 9, 10 can be tightened manually, or can be tightened via a device that imparts a controllable amount of tension on the retainer 8. When the first and second elongate straps 9, 10 are tightened, the outer diameter of the tube 2 will be reduced due to an elastic or plastic deformation of the tube wall 22. Therefore, the radius of curvature R of the curved base 40 can be similar to the radius of curvature of the outer surface 22a of the tube 2 in the tightened condition. The radius of curvature R of the curved base 40 can allow the curved base 40 to evenly distribute the pressure imparted on the tube 2 by the retainer 8 around the portion of the outer surface 22a that is contacted by the curved base 40. This functions to avoid gaps between the retainer 8 and the tube 2, which helps prevent gaps from forming between the tube 2 and the barb connector 3 in the area of the curved base 40 that otherwise might form when a flat base or no base is used.

As shown in FIGS. 7-10, the first and second locks 12, 13 are connected to the curved base 40. In particular, the first and second locks 12, 13 are connected to the radially outer surface 41 of the curved base 40, as the radially inner surface 42 is intended to contact the outer surface 22a of the tube 2. The first and second locks 12, 13 can be attached to said curved base 40 by first and second hinges 43, 44 to allow pivoting of the first and second locks 12, 13 relative to the curved base 40. The first and second hinges 43, 44 are formed as film hinges in the depicted embodiment, though other forms of hinges are contemplated. Even though separate first and second hinges 43, 44 are depicted, it shall be appreciated that one common hinge for both locks 12, 13 can also be utilized. Further, the first and second hinges 43, 44 may be integrally formed with the first and second locks 12, 13 and/or the curved base 40.

The first and second locks 12, 13 are spaced from the curved base 40 by the first and second hinges 43, 44 to allow the first and second locks 12, 13 to pivot relative to the curved base 40. The first and second hinges 43, 44 can be positioned such that the first and second locks 12, 13 are pivoted and biased against the curved base 40 as the first and second elongate straps 9, 10 are tightened. Moreover, the first and second hinges 43, 44 are positioned such that they are subject to a tension force in the tightened condition of the retainer 8. In the unpivoted state of the first and second locks 12, 13, a guiding path is defined through the first and second openings 31, 32 that runs straight through the first and second housings 33, 34, respectively. In the pivoted state, the guiding path preferably is oriented perpendicular to the curved base 40 such that the inlets of the openings 31, 32 are covered by the curved base 40. Due to this movement of the first and second locks 12, 13, a portion of each of the first and second elongate straps 9, 10 is pressed against the curved base 40 directly at the inlet of the first and second openings 31, 32. This may increase an even pressure distribution around the tube 2, which can help evenly bias the tube 2 against the cylindrical portion 6 and the tapered portion 7 of the barb connector 3.

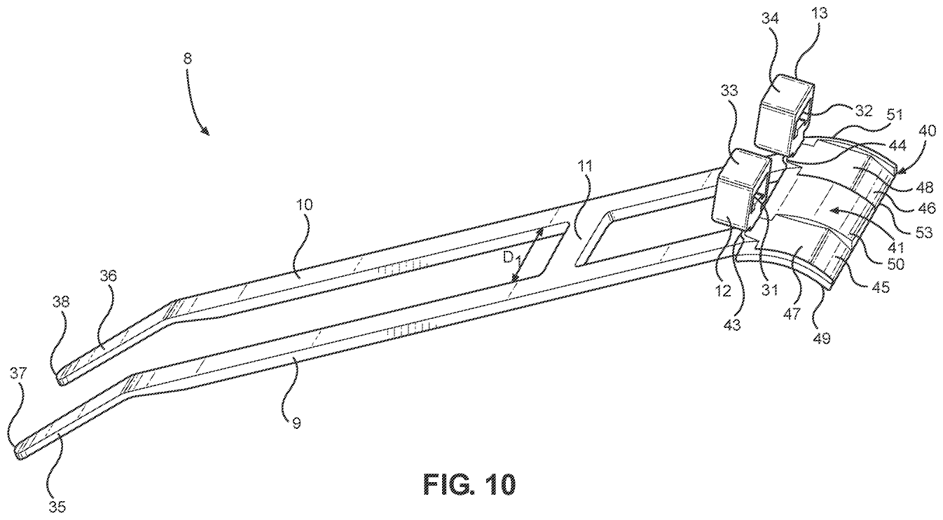

As best shown in FIG. 10, the curved base 40 may also include first and second guiding recesses 45, 46 that are configured to receive portions of the first and second elongate straps 9, 10, respectively when the retainer 8 is in the tightened condition. The first and second guiding recesses 45, 46 extend into the curved base 40 from the radially outer surface 41. The first and second guiding recesses 45, 46 may each include a flattened portion 47, 48, respectively, against which the first and second locks 12, 13 abut in the pivoted condition. As a result, when the first and second elongate straps 9, 10 are tightened, the guiding path that extends through the first and second openings 31, 32 of the first and second locks 12, 13, respectively, can extend substantially perpendicular to the flattened portions 47, 48 of the guiding recesses 45, 46. This allows a tensioning gun or other instrument being used to tighten the fastener 8 to face the tube 2 and barb connector 3 during operation. Wall 50 may be provided to separate the guiding recesses 45, 46 from each other and walls 49 and 51 may be provided at laterally opposite sides of the curved base 40 to provide a more stable and stiff structure for the curved base 40. Each of the first and second guiding recesses 45, 46 can taper along curved base 40 from a location adjacent the first and second hinges 43, 44 toward an edge 53 of the curved base 40. This can provide the first and second elongate straps 9, 10 a substantially smooth transition from the outer surface 22a of the tube 2 to the guiding recesses 45, 46. The first and second guiding recesses 45, 46 also avoid the inclusion of a step such that no void is formed between the respective first and second elongate straps 9, 10 and the outer surface 22a of the tube 2. Such a void could lead to an area without or with reduced radial pressure imposed to the tube 2. To avoid the formation of gaps between the tube 2 and the barb connector 3, it is preferred that the retainer 8 impart a pressure distribution around the circumference of the tube 2 that is as even as possible.

With reference to FIG. 9, the bridge 11 can be spaced from the curved base 40 by a second predetermined distance D2. In the tightened condition, the bridge 11 can be positioned approximately opposite the curved base 40 across the tube 2, as best seen in FIG. 1-3. By this arrangement, a relatively high stability is obtainable and can effectively prevent the first and second elongate straps 9, 10 from moving away from each other during the time that the retainer 8 is attaching the tube 2 to the barb connector 3. To achieve this, the second predetermined distance D2 can be approximately equal to the value of the outer radius of the tube in the tightened condition multiplied by pi. Alternatively the second predetermined distance D2 can be in the range of 0.5*pi*R to 1.5*pi*R, wherein R is the inner radius of curvature R of the curved base 40 (see FIG. 8), in the range of 0.75*pi*R to 1.25*pi*R, or in the range of 0.9*pi*R to 1.1*pi*R.

The bridge 11 forms a natural stop for the first and second elongate straps 9, 10 when they are guided through the first and second locks 12, 13. This means that for positioning the bridge 11 approximately opposite the curved base 40 across the tube 2 when the retainer 8 is in the tightened condition, the second predetermined distance D2 may be in the range of about half the length of the first and second elongate straps 9, 10 measured from the curved base 40 to the first and second locks 12, 13 when the first and second elongate straps 9, 10 are wrapped around the tube 2. This may be less than a length L of the jagged engagement surfaces 26, 27 in the direction of the first and second elongate straps 9, 10. The predetermined second distance D2 can be in the range of 0.25 to 0.75 times the length Z of said first and second elongate straps 9, 10.

In another embodiment (not shown), one, two, or more receiving straps can be assembled parallel along the length of the barb connector 3. The receiving straps have slots, such as two or more slots, to receive separate zip ties that can be fed by a user. The slots can be on either side of the maximum diameter end 19 of the tapered portion 7, such as the longitudinal positions of the first and second elongate straps 9, 10.

While the invention is described herein using a limited number of embodiments, these specific embodiments are not intended to limit the scope of the invention as otherwise described and claimed herein. The precise arrangement of various elements and order of the steps of articles and methods described herein are not to be considered limiting. For instance, although the steps of the methods are described with reference to sequential series of reference signs and progression of the blocks in the figures, the method can be implemented in a particular order as desired.

What is claimed is:

1. A retainer for maintaining a tube over a barb connector, the retainer comprising:
a first elongate strap;
a second elongate strap that is parallel to the first elongate strap;
a bridge between said first and second elongate straps, said bridge transversely spacing said first and second elongate straps by a predetermined first distance;
a first lock for locking said first elongate strap; and
a second lock for locking said second elongate strap.

2. The retainer of claim 1, wherein said bridge connects said first and second elongate straps.

3. The retainer of claim 1, wherein said first and second elongate straps comprise respective first end second jagged engagement surfaces and said first and second locks comprise respective first and second locking jacks for engagement with said first and second jagged engagement surfaces.

4. The retainer of claim 1, wherein said first and second elongate straps comprise respective first and second gripping tongues extending from said first and second elongate straps and forming respective terminal ends thereof.

5. The retainer of claim 1, further comprising:
a curved base, wherein said first and second elongate straps extend from said base.

6. The retainer of claim 5, wherein said bridge is spaced from said base by a predetermined second distance.

7. The retainer of claim 6, wherein said second distance is in the range of 0.25 to 0.75 times a length of said first elongate strap.

8. The retainer of claim 6, wherein said base has an inner curvature radius R and said second distance is in the range of 0.5*pi*R to 1.5*pi*R.

9. The retainer of claim 1, wherein said bridge has a width that is less than a width of said first elongate strap.

10. A retainer for maintaining a tube over a barb connector, the retainer comprising:
a curved base for contacting an outer surface of the tube;
a first elongate strap;
a second elongate strap that is parallel to the first elongate strap, the first and second elongate straps extending from the curved base;
a first lock for locking said first elongate strap;
and a second lock for locking said second elongate strap, the first and second locks connected to the curved base.

11. The retainer of claim 10, wherein said base transversely spaces said first and second elongate straps by a predetermined base distance from each other.

12. The retainer of claim 10, wherein said curved base has a first guiding recess and a second guiding recess,
wherein the first lock defines a first opening and a guide path that extends through the first opening, such that the first lock is partially disposed in the first guiding recess and the guide path of the first lock is substantially perpendicular to a portion of the first guiding recess when the first lock locks the first elongate strap, and
wherein the second lock defines a second opening and a guide path that extends through the second opening, such that the second lock is partially disposed in the second guiding recess and the guide path of the second lock is substantially perpendicular to a portion of the second guiding recess when the second lock locks the second elongate strap.

13. The retainer of claim 10 wherein said first and second locks are attached to said curved base by respective first and second hinges to allow pivoting said first and second locks relative to said curved base.

14. A tube connection system, comprising:
a barb connector defining a conduit therein, said barb connector having a terminal end, a cylindrical portion, and a tapered portion between said terminal end and said cylindrical portion, the tapered potion having a maximum outer diameter that is greater than an outer diameter of the cylindrical portion;
a tube received on said barb connector and extending at least over both said cylindrical portion and said tapered portion; and
a retainer for maintaining said tube over said barb connector, said retainer comprising:
a first elongate strap
a second elongate strap that is parallel to the first elongate strap;
a bridge between said first and second elongate straps, said bridge transversely spacing said first and second elongate straps by a predetermined first distance;
a first lock for locking said first elongate strap; and
a second lock for locking said second elongate strap,
wherein said first elongate strap secures said tube against said cylindrical portion, and said second elongate strap secures said tube against said tapered portion.

15. The tube connection system of claim 14, wherein said bridge is positioned generally opposite said first and second locks across said tube when the retainer secures said tube over said barb connector.

16. The tube connection system of claim 14, further comprising a curved base, wherein said first and second elongate straps extend from said base, said curvature of said base being substantially equal to a curvature of an outer surface of said tube.

17. A method of maintaining a tube against a barb connector, said method comprising:
disposing the tube over the barb connector;
providing a first elongate strap and a second elongate strap of a retainer around the tube, wherein said first and second elongate straps are transversely spaced by a bridge;
guiding said first and second elongate straps through respective first and second locks; and
tightening said first and second elongate straps against the tube such that the first elongate strap is around a first portion of the tube and the second elongate strap is around a second portion of the tube.

18. The method of claim 17, further comprising disposing a curved base of the retainer against an outer surface of the tube, wherein the first and second elongate straps extend from said curved base.

19. The method of claim 17, further comprising:
engaging a first jagged engagement surface of the first elongate strap with a first locking jack of the first lock; and
engaging a second jagged engagement surface of the second elongate strap with a second locking jack of the second lock.

20. The method of claim 17, wherein the bridge spaces the first and second elongate straps apart by a predetermined distance.
